(19) United States
(12) Patent Application Publication
(10) Pub. No.: US 2005/0268769 A1
(43) Pub. Date: Dec. 8, 2005

(54) Guitar assembly and method of making the same

(76) Inventor: Dennis Zager SR., Lincoln, NE (US)

Correspondence Address: Brian P. Hopkins, Esq.;Mintz, Levin, Coho, Ferris, Glovsky and Popeo, P.C, The Chrysler Center, 666 Third Avenue, 24th Floor, New York, NY, 10017, US

(21) Appl. No.: 10/861,276

(22) Filed: Jun. 4, 2004

(51) Int. Cl. G10D 3/00; G10D 3/04

(52) U.S. Cl. 84/314 N

(57) ABSTRACT

A guitar is presented which may include a nut having a first edge slot for receiving a first edge string, the first slot having a center point being positioned away from a first edge of the nut a first distance no less than about 3/32″, a saddle positioned in a bridge including a first portion having a height of greater than or equal to about 7/16″ as measured from the guitar top and a neck positioned at an angle greater than about 180 degrees from the guitar top.

### BACKGROUND OF THE INVENTION

1. Field of the Invention

The present invention relates to guitars in general, and more particularly, to acoustic guitars and corresponding components and method for improving the action and playability of acoustic guitars.

2. Background

Guitars are currently the most popular musical instruments in the world. Almost a billion dollars (US) of guitars are sold each year throughout the world, to players of varying playing ability, with a significant portion being purchased by beginner guitarists. In that regard, most beginners, for example, choose an acoustic guitar to learn on first, since, electric guitars are generally more expensive and require additional equipment in order to be played (e.g., an amplifier, effects, patch cables, etc.).

Guitars, however, guitars are not as easy to play or learn as one may think, especially acoustic guitars. Specifically, guitars require a sustained amount of fingertip pressure in order to clamp (“fret”) down on one or more strings at a particular fret(s) on the neck of the guitar. For a beginner guitarist (especially), the finger pain produced by “fretting” strings maybe so intense, that often, beginner guitarist give up playing immediately after picking up the guitar for the first time. For those who continue playing, fingers are subject to even more pain when a player attempts to learn further guitar techniques including, bends, vibrato, hammer-ons and pull-offs.

Moreover, not only must a player be able to provide the appropriate fingertip pressure to fret the strings, but a player must be able to position several fingertips adjacent one anther to fret nearby strings. To the inexperienced player—this is nearly impossible. Typically, one fingertip inadvertently touches another string (for example) adjacent the fretted string, which mutes the adjacent string, leading to a dull, thud like tone emanating from the string. Of course, this leads to quite a bit of frustration.

Accordingly, there exists a need for a guitar, especially an acoustic guitar, which is easy on the fingers for guitarists and easier to play overall.

### SUMMARY OF THE INVENTION

Accordingly, embodiments of the present invention present novel and non-obvious guitars, guitar components and processes for achieving an easier playing guitar.

In a first embodiment of the present invention, a guitar is presented and may include a nut having a first edge slot for receiving a first edge string, the first slot having a center point being positioned away from a first edge of the nut a first distance no less than about 3/32″, a saddle positioned in a bridge including a first portion having a height of greater than or equal to about 7/16″ as measured from the guitar top and a neck positioned at an angle greater than about 180 degrees from the guitar top.

The first distance may also be between about 3/32″ and about 5/32″, and the first slot may receive a high E or comparable guitar string.

The nut of the guitar in the first embodiment, for example, may include a second edge slot for receiving a second edge string. Such a second slot may include a center point positioned away from a second edge of the nut a second distance no less than about 1/16″, for example. Such a second slot may receive a low E or comparable string.

The second distance may be between about 1/16″ and about ⅛″.

The saddle height of the first embodiment may be between about 7/16″ and about ⅝″ as measured from the guitar top.

In another embodiment of the present invention, a guitar is presented which may include a nut having a first edge slot for receiving a first edge string, the first slot having a first center point positioned away from a first edge of the nut a distance no less than about 3/32″ to about 5/32″, a second edge slot for a second edge string, the second slot having a second center point being positioned away from a second edge of the nut a distance between about 1/16″ to about ⅛″, and a plurality of middle slots for receiving middle strings, the plurality of middle slots being substantially equally spaced apart between the first slot and the second slot.

In yet another embodiment of the present invention, a guitar is presented which may include a saddle positioned in a bridge, the saddle including a first portion having a height between about 7/16″ and about ⅝″ as measured from the guitar top.

In yet another embodiment of the invention, a guitar is presented which may include a neck positioned at an angle greater than about 180 degrees from the guitar top.

In still yet another embodiment of the invention, a method for manufacturing a guitar may include providing a nut having a first slot for receiving a first edge string, the first slot being positioned away from a first edge of the nut a distance between about 3/32″ to about 5/32″, a second slot for receiving a second edge string, the second slot positioned away from a second edge of the nut a distance between about 1/16″ to about ⅛″ and a plurality of middle strings substantially equally spaced apart between the position of the first edge string and the position of the second edge string. The method may also include providing a saddle positioned in a bridge, where a first portion of the saddle includes a height greater than or equal to about 7/16″ from the guitar top. The method may further include positioning the neck at an angle greater than about 180 degrees from the guitar top.

These and other embodiments, features, objects and advantages of the invention will be even more clear with reference to the attached drawings and detailed description which follows.

### BRIEF DESCRIPTION OF THE FIGURES

FIG. 1 illustrates a side view of a guitar according to an embodiment of the present invention.

FIG. 2 illustrates a side view of a headstock portion of a guitar according to an embodiment of the present invention.

FIG. 3 illustrates a side view of a saddle/bridge area of a guitar according to an embodiment of the invention.

FIG. 4A illustrates a top view of an area of a guitar where the nut is positioned according to an embodiment of the invention.

FIG. 5 illustrates a side-sectional view illustrating a truss-rod, and a neck angle of a guitar according to an embodiment of the invention.

FIG. 6 illustrates a side view of a guitar according to one embodiment of the present invention.

### DETAILED DESCRIPTION OF EMBODIMENTS

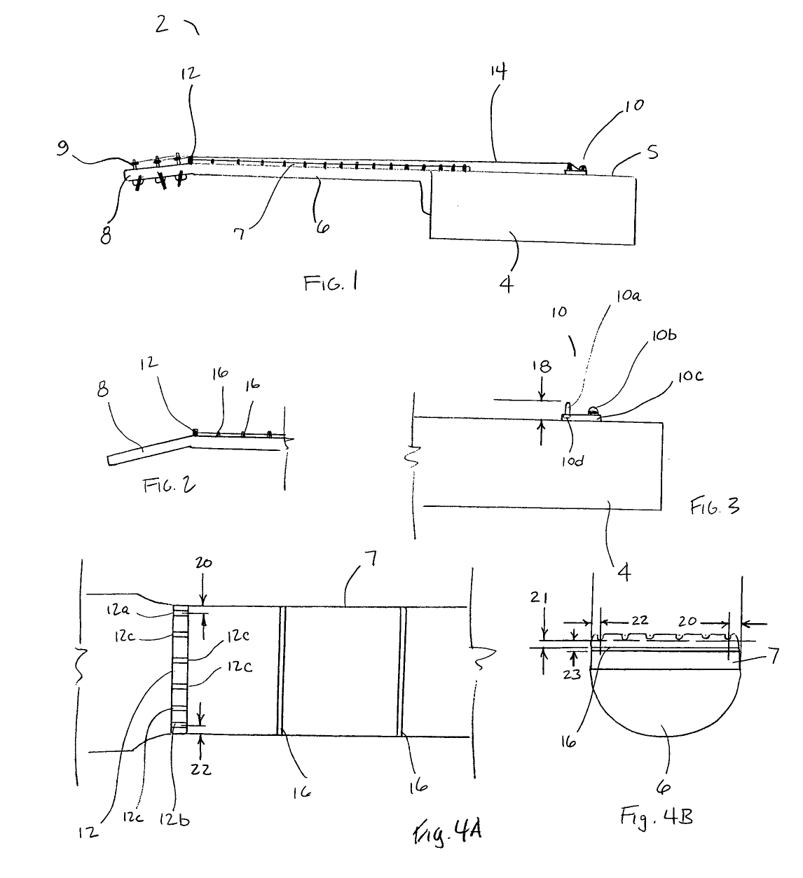

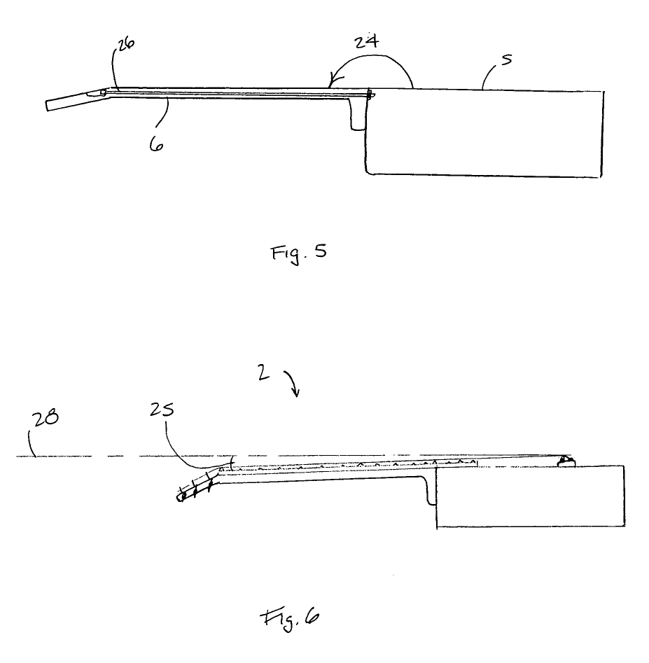

As shown in FIGS. 1-6, a guitar 2 includes body portion 4, neck 6 having a fretboard 7, headstock 8 having tuners 9, saddle-bridge combination 10 and nut 12. Stings 14, are connected at one end to tuners 9 and at the other end to the bridge 10. The guitar may be any guitar type, e.g., solid or hollow body, acoustic, electric, and acoustic/electric. For illustrative purposes, the embodiments of the present invention will be described with reference to a hollow body acoustic dreadnaught style guitar, for example (or other body size; e.g., concert/grand auditorium and concert/auditorium).

The saddle-bridge combination 10 may be comprised of a saddle 10a (e.g., bone, tursq, plastic and the like), which is typically received in a slot 10d of the bridge 10c. Bridge pins 10b secure the ends of the strings into the bridge/guitar top. The guitar may include a plurality of strings—typically, six or 12 strings, or less (bass guitars). For illustrative purposes, the acoustic guitar described herein will be described as having 6 strings, which may be tuned to standard tuning (e.g., high E, B, G, D, A, low E), of any gauge.

The fretboard 7 may include a plurality of frets 16 positioned at predetermined positions along the fretboard, at increments which result in half-step note changes along each string. Typically, acoustic guitars include between 12 and 24 frets. The nut 12 is positioned between the headstock, and the end of the neck/fretboard, and is used to hold the position the strings at one end of the guitar.

Typically, the width of a guitar neck/fretboard is between about 1¾″ and about 2″, and more preferably, between about 1¾″ and about 1⅞″, depending upon the manufacturer and type of guitar.

The nut includes a plurality of slots, edge slots 12a and 12b, and a plurality of middle slots 12c, for receiving, for example, the high E string, the low E string and the A, D, G and B strings, respectively. A bottom surface of the nut is typically glued to the neck or portion of the fretboard, and/or a surface of the nut facing the guitar body is glued to the fretboard.

In some embodiments of the invention, the spacing between the slots of the nut are positioned at predetermined points along the width of the fretboard/neck, to establish a widest possible spacing in contrast to what is currently provided on prior art guitars. This provides more space for each finger tip so that strings adjacent to a fretted string are not inadvertently muted to increase the playability (i.e., make the guitar easier to play). Moreover, some of these embodiments provide the edge strings (e.g., std. tuning: low E and high E), as close as possible to the edge of the fretboard. In such embodiments, the space between the two edge strings may be substantially equally divided up for the positions of the remainder of the strings (middle strings: e.g., std. tuning A, D, G and B). This allows a player to better utilize, for example, his thumb in fretting the low E string. Current guitar necks of 1¾″, for example, have the edge slots of the nut positioned about 7/32″ or more from the edge of the neck/fretboard.

Accordingly, the high E string, for example, may be placed between about 1/32″ and about 3/16″, and more preferably between about 3/32″ and about 5/32″. The low E string, for example, may be placed between about 1/32″ and about 3/16″, and more preferably between about 1/16″ and about ⅛″. Accordingly, compared to the nut/string spacings currently used on acoustic guitars, the slot arrangements in some embodiments of the present invention may free up nearly another 5/16″ (at least) of space (divided among the spacing for the middle strings).

One reason having the edge slots/strings as close as possible to the sides of the fret board/neck in some embodiments of the invention is to enable easier playability of the guitar, in at least two ways. First, the closer the slots/strings are to the edge, the more space is freed up between the two edge strings for the remaining strings. Secondly, a player may now more easily fret the low E string with his thumb, instead of relying on the use of four fretting fingers.

The depth of the slots on the nut relate typically to the distance between the top edge of the nut and the top of the frets. Thus, if the top edge of the nut is located ⅛″ from the top of the frets (e.g., the first fret), the depth of the slot may be between about 1/64″ and about 7/64″, depending upon the desired action. Again, these distances are relative to the height of the nut from the keyboard, and one skilled in the art will understand that depth of the slots may be formed such that the bottom of the slots are at least slightly higher than the top of the first fret.

The playability of a guitar also relates to the “action” of a guitar. The action of the guitar relates to the distance from the bottom of the strings to the top of the frets and/or to the top of the fretboard. With low action, a player need not have to apply a great amount of pressure to “fret” the string at a corresponding fret with a finger. Specifically, as a guitar string is bent so that it contacts a fret, more tension is generated in the string; the less a string is “bent”, the less tension in the string. This directly correlates to less finger pressure necessary to bend the string to come into contact with the fret.

Accordingly, less finger pressure corresponds to easier playability. However, low string height hampers heavy handed strumming (e.g., to create volume), since when strings are strummed hard, the amplitude of the string vibrating is larger than the distance the string is from the top of one or more frets resulting in “buzzing”. Buzzing significant detracts from the way the guitar sounds when played.

The action of the guitar is typically determined by at least one of four factors (and typically, is determined by all four factors): the depth of the slots of the guitar nut, the height of the frets off the fretboard (i.e., the effective height from the fretboard and/or frets to the bottom of the slots), the height of the saddle and the angle of the guitar neck to the top of the guitar. The depth of the slots of the nut may vary slot to slot across the width of the fretboard, since the fretboard/frets, from one side of the neck to the other (width) may be slightly convex (or concave), but typically, on a quality instrument, the depth of all the slots of the nut are substantially the same.

Action may also be affected by the relief (i.e., curvature) of the guitar neck/fretboard (slight concave shape, length wise from one end of the neck to the other). Specifically, with a flat neck/fretboard, substantially all of the frets may be the same height. With a slight concave shape, frets in the middle of the neck, for example, may be slightly higher off the fretboard. Relief may be pre-formed in the neck prior to assembly of the guitar and/or may be established and changed via adjustments of the truss rod 26 (for example).

The angle that the neck of the guitar makes with the top of the guitar also plays an important role in action and playability of the guitar, as well as the ease at which the action and playability may be adjusted. Accordingly, in a preferred embodiment of the present invention, a “backward” leaning neck is provided.

Moreover, novel and non-obvious features of the present invention also include the corresponding relationship between neck/fretboard angle and the saddle height (such features may also relate to nut slot depth). Specifically, Applicants invention is contrary to past and existing knowledge in the art. Currently, the angle that the guitar neck/fretboard makes with the guitar top is less than 180 degrees and saddle height (as measured from the guitar top) is typically between ¼″ and ⅜″ (the saddle being within a slot of the bridge).

In contrast, in preferred embodiments of the present invention, a backward leaning neck (e.g., angle that the neck/fretboard makes with the guitar top is greater than about 180 degrees) and a taller saddle (and in some embodiments, an overly tall saddle) may be used. Typically, the angle that the neck/fretboard makes with the guitar top may be established by the relationship of the joint between the neck and the guitar body. However, this angle may also be established by adjustments made to the truss rod.

With regard to the saddle height (from the guitar top), the height of, for example, the tallest portion of the saddle, may be between, for example, ⅜″ and about ⅞″ (when the saddle is positioned within the slot of the bridge), and more preferably between about ⅜″ and about ¾″, and most preferably between about 7/16″ and about ⅝″, as measured from the guitar top.

Such a relationship may allow for a greater amount of adjustability of the action of the guitar. Specifically, a first low action setting may include a particular backward leaning angle of the neck and a particular tall saddle. This first action setting may be established for fingerstyle or light strumming. With slight turning of the truss rod, the angle could be slightly lessoned (but still greater than 180 degrees, for example), and the height of the strings may be increased, establishing a second action setting for say, heavy strumming.

Using one or more of the disclosed neck angle, depth of the slots of the nut and the saddle height, a minimum distance from the top of one or more of the frets (for example) to a bottom of one or more (preferably all) strings may be preferably about 1/64″, and perhaps less, and, more preferably in other embodiments, the distance may be about 1/32″ or less. With some embodiments, this distance may be between about 1/64″ and about ⅛″.

Furthermore, in some embodiments, for example, an exact height of the saddle, a depth of one or more of the slots of the nut and an exact backward leaning neck angle may be ultimately determined by the distance between the top of a fret (or frets) located in the middle of the neck (i.e., lengthwise). Specifically, one or more of these specifications may be finally determined upon the distance between the top of a middle fret, for example, and the bottom of one or more of the strings is between about 1/64″ and about 3/16″, and preferably between about 1/32″ and 3/32″. Such a middle fret, on an acoustic guitar, for example, may be the 12^{th} fret.

In still other embodiments, the above described features may be mixed and matched to suit a particular playing style, and thus, a straight angle neck (180 degrees to the top), or even a neck with a forward lean (less than 180 degrees), may be used.

FIG. 6 illustrates one of the preferred embodiments of the backward leaning neck and tall saddle. As shown, the top of the guitar 2 is preferable substantially parallel with the horizontal reference line 28. The neck/fretboard combination includes a backward leaning neck angle 25, from the horizontal. As shown in this embodiment, the strings are preferably substantially parallel to the angle of the neck.

Accordingly, these combination of specific features outlined above, allow for a guitar with increased playability.

Having now described a few embodiments of the invention, it should be apparent to those skilled in the art that the foregoing is merely illustrative and not limiting, having been presented by way of example only. All embodiments may be structured for use on any current or future capo device. Numerous modifications and other embodiments are within the scope of ordinary skill in the art and are contemplated as falling within the scope of the invention.

1. A guitar comprising:
a nut having a first edge slot for receiving a first edge string, the first slot having a center point being positioned away from a first edge of the nut a first distance no less than about 3/32″;
a saddle positioned in a bridge including a first portion having a height of greater than or equal to about 7/16″ as measured from the guitar top; and
a neck positioned at an angle greater than about 180 degrees from the guitar top.

2. The guitar according to claim 1, wherein the first distance is between about 3/32″ and about 5/32″.

3. The guitar according to claim 1, wherein the first slot is for receiving a high E or comparable guitar string.

4. The guitar according to claim 1, wherein the nut includes a second edge slot for receiving a second edge string, the second slot having a center point positioned away from a second edge of the nut a second distance no less than about 1/16″.

5. The guitar according to claim 4, wherein the second slot is for receiving a low E or comparable string.

6. The guitar according to claim 4, wherein the second distance is between about 1/16″ and about ⅛″.

7. The guitar according to claim 1, wherein the nut includes a plurality of middle slots positioned between the first edge slot and a second edge slot, for receiving corresponding strings.

8. The guitar according to claim 1, wherein the saddle height is between about 7/16″ and about ⅝″ as measured from the guitar top.

9. A guitar comprising a nut having a first edge slot for receiving a first edge string, the first slot having a first center point positioned away from a first edge of the nut a distance no less than about 3/32″ to about 5/32″, a second edge slot for a second edge string, the second slot having a second center point being positioned away from a second edge of the nut a distance between about 1/16″ to about ⅛″, and a plurality of middle slots for receiving middle strings, the plurality of middle slots being substantially equally spaced apart between the first slot and the second slot.

10. A guitar comprising a saddle positioned in a bridge, the saddle including a first portion having a height between about 7/16″ and about ⅝″ as measured from the guitar top.

11. A guitar comprising a neck positioned at an angle greater than about 180 degrees from the guitar top.

12. A method for manufacturing a guitar comprising:
providing a nut having:
a first slot for receiving a first edge string, the first slot being positioned away from a first edge of the nut a distance between about 3/32″ to about 5/32″;
a second slot for receiving a second edge string, the second slot positioned away from a second edge of the nut a distance between about 1/16″ to about ⅛″;
a plurality of middle strings substantially equally spaced apart between the position of the first edge string and the position of the second edge string;
providing a saddle positioned in a bridge, wherein a first portion of the saddle includes a height greater than or equal to about 7/16″ from the guitar top; and
positioning the neck positioned at an angle greater than about 180 degrees from the guitar top.
